(19) United States
(12) Patent Application Publication
(10) Pub. No.: US 2016/0091970 A1
(43) Pub. Date: Mar. 31, 2016

(54) HEAD-MOUNTED DISPLAY APPARATUSES

(71) Applicant: OmniVision Optoelectronics Technologies (Shanghai) Co., Ltd., Shanghai (CN)

(72) Inventor: Regis FAN, Shanghai (CN)

(21) Appl. No.: 14/794,725

(22) Filed: Jul. 8, 2015

(30) Foreign Application Priority Data
Sep. 30, 2014 (CN) 201410522328.X

(51) Int. Cl. G06F 3/01; G06T 19/00; G02B 27/14; G02B 27/01; G02B 27/00

(52) U.S. Cl. CPC G06F 3/013; G02B 27/0172; G02B 27/0093; G02B 27/141; G06T 19/006; G02B 2027/0138; G02B 2027/014

(57) ABSTRACT

A head-mounted display apparatus is disclosed, the apparatus includes a reflective microdisplay, a visible light source, an illumination optics unit, an imaging optics unit and an eye tracker module which includes an invisible light source and a sensor. The invisible light source emanates an invisible light beam which is subsequently received by the imaging optics unit and directed thereby into an eye of a user. The sensor receives the invisible light beam reflected back from the eye of the user and thereby captures an image of the eye, on the basis of which, a position of the eye is determinable by calculation. The apparatus has the advantage of an improvement in the accuracy of the object tracking and does not have influence on the user at all.

### CROSS-REFERENCES TO RELATED APPLICATIONS

This application claims the priority of Chinese patent application number 201410522328.X, filed on Sep. 30, 2014, the entire contents of which are incorporated herein by reference.

### TECHNICAL FIELD

The present invention relates to display devices and, in particular, to head-mounted display apparatuses.

### BACKGROUND

Nowadays, head-mounted displays (HMD), such as head-mounted glasses, have found common use in the viewing of pictures, text files and other documental data.

However, conventional HMDs are still subject to constraints in terms of having to rely on some sort of pointer for communicating display instructions. For example, a mouse is necessary for a computer, and a touch device must rely on a finger or a stylus for accomplishing such tasks. This requires a user's hand manipulations rather than head or HMD movements which allow automatic control of the displayed screen. Therefore, the conventional HMDs suffer from a lack of user interactivity.

### SUMMARY OF THE INVENTION

It is an objective of the present invention to provide head-mounted display apparatuses each using an eye tracker module to monitor the position of an eye and thereby acquire a direction and an angle of the eye staring at an image, which makes it possible to control the displayed image and to track an object. In addition, the accuracy of the object tracking can be improved by a coaxial arrangement of the apparatuses.

In accordance with the above and further objectives of the invention, a head-mounted display apparatus is provided, including:

a reflective microdisplay;

a visible light source configured to illuminate the microdisplay;

illumination optics unit configured to direct visible light emanated from the visible light source into the microdisplay, and allow light reflected from the microdisplay in the form of an image to pass therethrough and transmit along an optical axis;

an imaging optics unit configured to project the image from the microdisplay into an eye of a user; and

an eye tracker module, including:
an invisible light source configured to emanate an invisible light beam into the illumination optics unit, the illumination optics unit configured to reflect the invisible light beam along said optical axis, the imaging optics unit configured to receive and direct the invisible light beam into the eye of the user; and
a sensor configured to receive the invisible light beam reflected back from the eye of the user and to capture an image of the eye.

Optionally, the reflective microdisplay may be a liquid crystal on silicon display or a digital light processing display.

Optionally, the image from the microdisplay projected into the eye of a user may be a virtual image.

Optionally, the eye tracker module may further include a processor for receiving the image of the eye from the sensor and for monitoring a position of the eye.

Optionally, the sensor may provide a real image for monitoring the position of the eye.

Optionally, the processor may calculate the position of the eye by using an algorithm.

Optionally, the imaging optics unit may be disposed downstream to the illumination optics unit along the optical axis, with the eye tracker module disposed on a first side of the illumination optics unit, and with the visible light source disposed on a second side of the illumination optics unit opposite to the first side.

Optionally, the illumination optics unit may include a first beam splitter arranged with an angle of about 45 degrees relative to the optical axis.

Optionally, the imaging optics unit may include a second beam splitter and an imaging lens, arranged along the optical axis, the second beam splitter has a first surface for receiving and allowing both the image from the microdisplay and the invisible light beam to pass therethrough, the imaging lens is configured to reflect the image from the microdisplay and the invisible light beam toward a second surface of the second beam splitter, and second surface of the second beam splitter is configured to reflect the image from the microdisplay and the invisible light beam into the eye of the user.

Optionally, the imaging optics unit may include a second beam splitter and an imaging lens arranged along the optical axis and a reflector, the second beam splitter has a first surface that allows the image from the microdisplay to pass therethrough and reflects the invisible light beam toward the reflector, wherein the first surface of the second beam splitter is further configured to allow the invisible light beam reflected from the reflector to pass therethrough into the eye of the user, the imaging lens is configured to reflect the image from the microdisplay toward a second surface of the second beam splitter, and the second surface of the second beam splitter is configured to reflect the image from the microdisplay into the eye of the user.

Optionally, the invisible light source may be an infrared light-emitting diode light source.

The present invention further provides a head-mounted display apparatus, which includes:

a reflective microdisplay;

a visible light source configured to illuminate the microdisplay;

a first illumination optics unit configured to direct visible light emanated from the visible light source into the microdisplay, and allow light reflected from the microdisplay in the form of an image to pass therethrough along an optical axis;

a second illumination optics unit disposed downstream to the first illumination optics unit along said optical axis and allowing the image from the microdisplay to pass therethrough;

an imaging optics unit configured to project the image from the microdisplay into an eye of a user; and

an eye tracker module, including:
an invisible light source configured to emanate an invisible light beam into the second illumination optics unit, the second illumination optics unit configured to reflect the invisible light beam along said optical axis, the imaging optics unit configured to receive and direct the invisible light beam into the eye of the user; and
a sensor configured to receive the invisible light beam reflected back from the eye of the user and to capture an image of the eye.

Optionally, the reflective microdisplay may be a liquid crystal on silicon display or a digital light processing display.

Optionally, the image from the microdisplay projected into the eye of a user may be a virtual image.

Optionally, the eye tracker module may further include a processor for receiving the image of the eye from the sensor and for monitoring a position of the eye.

Optionally, the sensor may provide a real image for monitoring the position of the eye.

Optionally, the processor may calculate the position of the eye by using an algorithm.

Optionally, the first illumination optics unit, the second illumination optics unit and the imaging optics unit may be successively arranged along the optical axis, with the eye tracker module and the visible light source disposed on a same side of the second illumination optics unit and the first illumination optics unit, respectively.

Optionally, the first illumination optics unit may include a first beam splitter arranged with an angle of about 45 degrees relative to the optical axis and the second illumination optics unit may include a second beam splitter arranged with an angle of about 45 degrees relative to the optical axis, wherein the first beam splitter and the second beam splitter is orthogonal to each other.

Optionally, the imaging optics unit may include a third beam splitter and an imaging lens, arranged along the optical axis, the third beam splitter has a first surface for receiving and allowing both the image from the microdisplay and the invisible light beam to pass therethrough, the imaging lens is configured to reflect the image from the microdisplay and the invisible light beam toward a second surface of the third beam splitter, and the second surface of the third beam splitter is configured to reflect the image from the microdisplay and the invisible light beam into the eye of the user.

Optionally, the imaging optics unit may include a third beam splitter and an imaging lens arranged along the optical axis and a reflector, the third beam splitter has a first surface that allows the image from the microdisplay to pass therethrough and reflects the invisible light beam toward the reflector, wherein the first surface of the third beam splitter is further configured to allow the invisible light beam reflected from the reflector to pass therethrough into the eye of the user, the imaging lens is configured to reflect the image from the microdisplay toward a second surface of the third beam splitter, and the second surface of the third beam splitter is configured to reflect the image from the microdisplay into the eye of the user.

Optionally, the invisible light source may be an infrared light-emitting diode light source.

The present invention still further provides a head-mounted display apparatus, including:

a transmissive microdisplay;

a visible light source configured to illuminate a back of the microdisplay, such that light in the form of an image is transmitted from a front of the microdisplay along an optical axis;

an illumination optics unit configured to receive and allow the image from the microdisplay to pass therethrough;

an imaging optics unit configured to project the image from the microdisplay into an eye of a user; and

an eye tracker module, including:
an invisible light source configured to emanate an invisible light beam into the illumination optics unit, the illumination optics unit configured to reflect the invisible light beam along said optical axis, the imaging optics unit configured to receive and direct the invisible light beam into the eye of the user; and
a sensor configured to receive the invisible light beam reflected back from the eye of the user and to capture an image of the eye.

Optionally, the illumination optics unit may include a first beam splitter arranged with an angle of about 45 degrees relative to the optical axis.

Optionally, the imaging optics unit may include a second beam splitter and an imaging lens arranged along the optical axis, the second beam splitter has a first surface for receiving and allowing both the image from the microdisplay and the invisible light beam to pass therethrough, the imaging lens is configured to reflect the image from the microdisplay and the invisible light beam toward a second surface of the second beam splitter, and the second surface of the second beam splitter is configured to reflect the image from the microdisplay and the invisible light beam into the eye of the user.

Optionally, the imaging optics unit may include a second beam splitter and an imaging lens arranged along said optical axis and a reflector, the second beam splitter has a first surface that allows the image from the microdisplay to pass therethrough and reflects the invisible light beam toward the reflector, the first surface of the second beam splitter is further configured to allow the invisible light beam reflected from the reflector to pass therethrough into the eye of the user, wherein the imaging lens is configured to reflect the image from the microdisplay toward a second surface of the second beam splitter, and the second surface of the second beam splitter is configured to reflect the image from the microdisplay into the eye of the user.

Compared to the conventional HMDs, the head-mounted display apparatuses according to the present invention have the following advantages.

1) They are each provided with an eye tracker module including an invisible light source and a sensor. The invisible light source emanates an invisible light beam which is then received by an imaging optics unit and is directed thereby into an eye of the user. The sensor receives the invisible light beam reflected back from the eye of the user and thus captures an image of the eye, based of which a position of the eye is determinable by calculation. Monitoring the position of the eye allows obtaining a direction and an angle in and at which the eye is staring at an image. This makes it possible to control the displayed image and to track an object.

2) The invisible light beam emanated from the invisible light source enters the illumination optics unit and thereby travels along an optical axis of the invisible light. This results in an improvement in the accuracy of the object tracking. Further, the invisible light beam does not affect the user at all.

### BRIEF DESCRIPTION OF THE DRAWINGS

FIG. 1 is a schematic illustration of a head-mounted display apparatus in accordance with Embodiment 1 of the present invention.

FIG. 2 is a schematic illustration of a head-mounted display apparatus in accordance with Embodiment 2 of the present invention.

FIG. 3 is a schematic illustration of a head-mounted display apparatus in accordance with Embodiment 3 of the present invention.

FIG. 4 is a schematic illustration of a head-mounted display apparatus in accordance with Embodiment 4 of the present invention.

FIG. 5 is a schematic illustration of a head-mounted display apparatus in accordance with Embodiment 5 of the present invention.

FIG. 6 is a schematic illustration of a head-mounted display apparatus in accordance with Embodiment 6 of the present invention.

### DETAILED DESCRIPTION

The present invention will become apparent from the following further description which is to be read in connection with the accompanying drawings. It is to be understood as a matter of course that the present invention is not limited to the several specific embodiments set forth below and any common alternative thereto known by those skilled in the art also falls in the scope of the invention.

In addition, the accompanying drawings that are intended merely for detailed description of the exemplary embodiments of the present invention may not be drawn to scale for the sake of clarity or simplicity and should thus not be construed as limiting the invention in any way.

The core principle of the present invention is to enable the control of a displayed image and tracking of an object by using an eye tracker module including an invisible light source and a sensor, wherein the invisible light source emanates an invisible light beam that is then received by an imaging optics unit and directed thereby into an eye of a user, and the sensor receives the invisible light beam reflected back from the eye of the user and thus captures an image of the eye, and by monitoring the position of the eye to obtain a direction and an angle in and at which the eye is staring.

### Embodiment 1

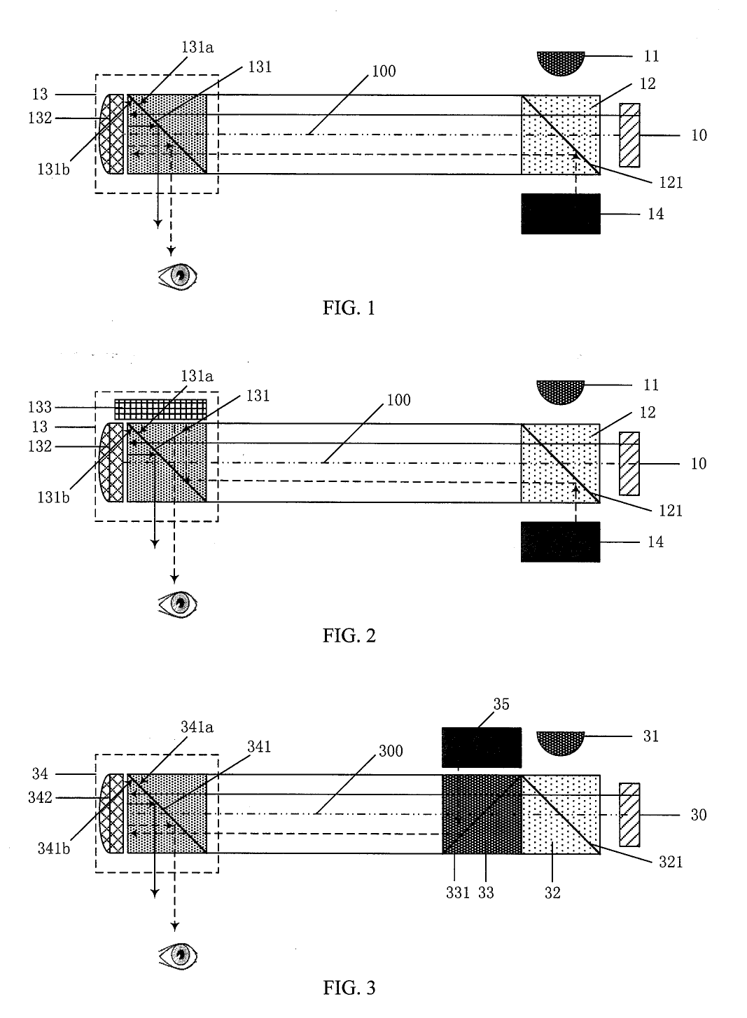

Reference is first made to FIG. 1, which diagrammatically illustrates a head-mounted display apparatus in accordance with Embodiment 1 of the present invention. As shown in the figure, the head-mounted display apparatus includes:

a reflective microdisplay 10, a visible light source 11, an illumination optics unit 12, an imaging optics unit 13 and an eye tracker module 14. The visible light source 11 is configured to illuminate the microdisplay 10. The illumination optics unit 12 is configured to direct visible light emanated from the visible light source 11 into the microdisplay 10 and to allow light reflected from the microdisplay 10 carrying an image to pass through the illumination optics unit 12 and transmit along an optical axis 100. The imaging optics unit 13 is configured to project the image from the microdisplay 10 into an eye of a user (as indicated by the arrowed solid lines in FIG. 1). The eye tracker module 14 includes an invisible light source and a sensor. The invisible light source is adapted to emanate an invisible light beam into the illumination optics unit 12 which then makes the invisible light beam travel along the optical axis 100. The imaging optics unit 13 is configured to receive and direct the invisible light beam into the eye of the user (as indicated by the arrowed dashed lines in FIG. 1). The sensor is configured to receive the invisible light beam reflected back from the eye of the user and to thereby capture an image of the eye. It is noted that the arrowed solid and dashed lines in FIG. 1 are intended solely to indicate directions of different light beams, and, in case of the directions being the same, the lines should coincide but are still presented in the figure as separate lines in order to show that they represent distinct light beams.

The eye tracker module 14 further includes a processor for receiving the image of the eye from the sensor and for using an algorithm to calculate a position of the eye. The image received by the sensor is a real image for aiding the sensor to monitor the position of the eye. The monitoring of the position of the eye allows knowing a direction and angle of the eye staring at the image from the microdisplay, based on which a portion of the image at which the eye is staring can be determined. This enables the control of the displayed image and the tracking of an object. In addition, without affecting the user at all, the invisible light beam emanated from the invisible light source, after passing through the illumination optics unit 12, travels coaxially with the visible light along the optical axis 100, which results in an improvement in the accuracy of the object tracking. Further, the coaxial transmission of the beams establishes a known relationship between the sensor in the eye tracker module 14 and the microdisplay 10, thereby making the eye tracker module 14 free of the need for calibration.

The reflective microdisplay 10 is a liquid crystal on silicon (LCoS) display or a digital light processing (DLP) display. The image from the microdisplay 10 is a virtual image. The invisible light source is implemented as an infrared light-emitting diode (LED) light source.

In this embodiment, the imaging optics unit 13 is disposed downstream to the illumination optics unit 12 along the optical axis 100. Additionally, the eye tracker module 14 is disposed on a first side of the illumination optics unit 12, and the visible light source 11 on a second side of the illumination optics unit 12 that is opposite to the first side. Moreover, the illumination optics unit 12 includes a first beam splitter 121 that is arranged with an angle of about 45 degrees relative to the optical axis 100. Further, the imaging optics unit 13 includes a second beam splitter 131 and an imaging lens 132, both arranged along the optical axis 100. The second beam splitter 131 has a first surface 131a and a second surface 13lb. The first surface 131a is adapted for reception and passage therethrough of both the image from the microdisplay 10 and the invisible light beam. The imaging lens 132 is configured to reflect the image and the invisible light beam toward the second surface 131b which then reflect the image and the invisible light beam further into the eye of the user.

### Embodiment 2

With combined reference to FIGS. 1 and 2, this embodiment differs from Embodiment 1 in the structure of the imaging optics unit 13. In this embodiment, the imaging optics unit 13 includes a second beam splitter 131, an imaging lens 132 and a reflector 133. The second beam splitter 131 has a first surface 131a and a second surface 131b. The first surface 131a allows the image from the microdisplay 10 to pass therethrough and reflects the invisible light beam toward the reflector 133. The first surface 131a is further configured to allow the invisible light beam reflected from the reflector 133 to pass therethrough into the eye of the user. The imaging lens 132 is configured to reflect the image that has passed through the first surface 131a toward the second surface 131b which then reflects the image into the eye of the user, as shown in FIG. 2.

### Embodiment 3

Reference is now made to FIG. 3, which schematically illustrates a head-mounted display apparatus in accordance with Embodiment 3 of the present invention. As illustrated, the head-mounted display apparatus includes:

a reflective microdisplay 30, a visible light source 31, a first illumination optics unit 32, a second illumination optics unit 33, an imaging optics unit 34 and an eye tracker module 35. The visible light source 31 is configured to illuminate the microdisplay 30. The first illumination optics unit 32 is configured to direct visible light emanated from the visible light source 31 into the microdisplay 30 and to allow light reflected from the microdisplay 30 carrying an image to pass through the first illumination optics unit 32 and transmit along an optical axis 300. The second illumination optics unit 33 is disposed downstream to the first illumination optics unit 32 along the optical axis 300 and allows the image from the microdisplay 30 to pass therethrough. The imaging optics unit 34 is configured to project the image from the microdisplay 30 into an eye of a user (as indicated by the arrowed solid lines in FIG. 3). The eye tracker module 35 includes an invisible light source and a sensor. The invisible light source is adapted to emanate an invisible light beam into the second illumination optics unit 33 which then makes the invisible light beam travel along the optical axis 300. The imaging optics unit 34 is configured to receive and direct the invisible light beam into the eye of the user (as indicated by the arrowed dashed lines in FIG. 3). The sensor is configured to receive the invisible light beam reflected back from the eye of the user and to thereby capture an image of the eye. It is noted that the arrowed solid and dashed lines in FIG. 3 are intended solely to indicate directions of different light beams, and, in case of the directions being the same, the lines should coincide but are still presented in the figure as separate lines in order to show that they represent distinct light beams.

The eye tracker module 35 further includes a processor for receiving the image of the eye from the sensor and for using an algorithm to calculate a position of the eye. The image received by the sensor is a real image for aiding the sensor to monitor the position of the eye. The monitoring of the position of the eye allows knowing a direction and angle of the eye staring at the image from the microdisplay, based on which a portion of the image at which the eye is staring can be determined. This enables the control of the displayed image and the tracking of an object. In addition, without affecting the user at all, the invisible light beam emanated from the invisible light source, after passing through the second illumination optics unit 33, travels coaxially with the visible light along the optical axis 300, which results in an improvement in the accuracy of the object tracking. Further, the coaxial transmission of the beams establishes a known relationship between the sensor in the eye tracker module 35 and the microdisplay 30, thereby making the eye tracker module 35 free of the need for calibration.

The reflective microdisplay 30 is an LCoS display or a DLP display. The image from the microdisplay 30 is a virtual image. The invisible light source is an LED light source.

In this embodiment, the first illumination optics unit 32, the second illumination optics unit 33 and the imaging optics unit 34 are successively arranged along the optical axis 300. Additionally, the eye tracker module 35 is disposed on a first side of the second illumination optics unit 33, and the visible light source 31 on a first side of the first illumination optics unit 32. The eye tracker module 35 and the visible light source 31 are disposed on a same side of the second illumination optics unit 33 and the first illumination optics unit 32, respectively. Moreover, the first illumination optics unit 32 includes a first beam splitter 321 arranged with an angle of about 45 degrees relative to the optical axis 300. Further, the second illumination optics unit 33 includes a second beam splitter 331 that is arranged with an angle of about 45 degrees relative to the optical axis 331 and is orthogonal to the first beam splitter 321. Furthermore, the imaging optics unit 34 includes a third beam splitter 341 and an imaging lens 342, both arranged along the optical axis 300. The third beam splitter 341 has a first surface 341a and a second surface 341b. The first surface 341a is adapted for reception and passage therethrough of both the image from the microdisplay 30 and the invisible light beam. The imaging lens 342 is configured to reflect the image and the invisible light beam toward the second surface 341b which then reflect the image and the invisible light beam further into the eye of the user.

### Embodiment 4

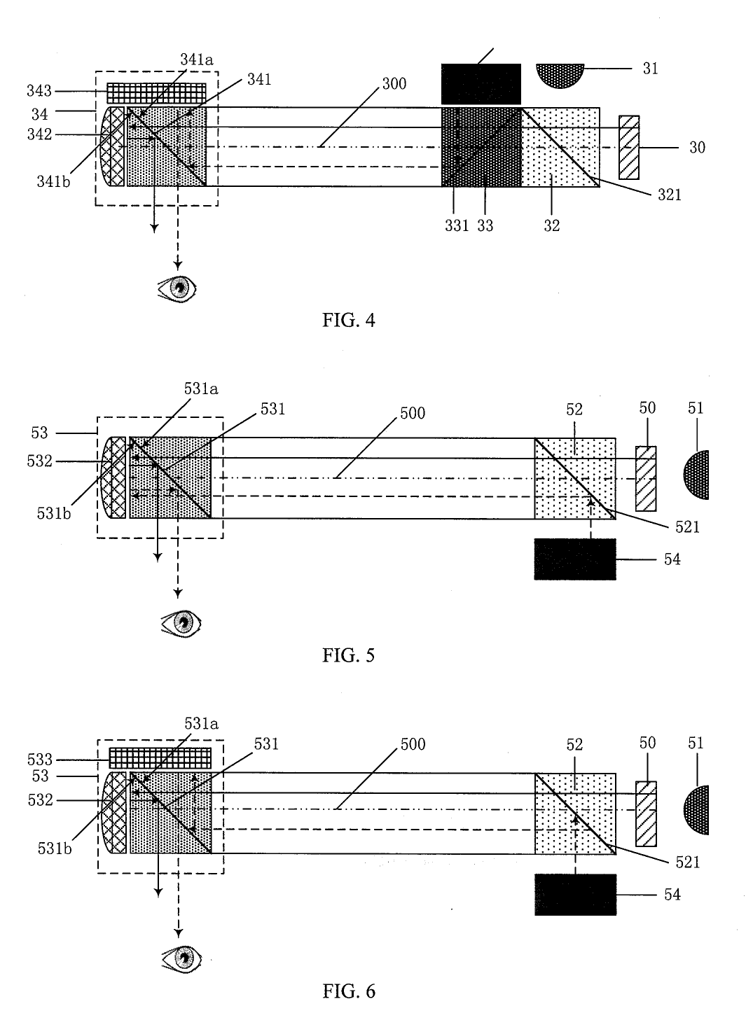

With combined reference to FIGS. 3 and 4, this embodiment differs from Embodiment 3 in the structure of the imaging optics unit 34. In this embodiment, the imaging optics unit 34 includes a third beam splitter 341, an imaging lens 342 and a reflector 343. The third beam splitter 341 has a first surface 341a and a second surface 341b. The first surface 341a allows the image from the microdisplay 30 to pass therethrough and reflects the invisible light beam toward the reflector 343. The first surface 341a is further configured to allow the invisible light beam reflected from the reflector 343 to pass therethrough into the eye of the user. The imaging lens 342 is configured to reflect the image that has passed through the first surface 341a toward the second surface 341b which then reflects the image into the eye of the user, as shown in FIG. 4.

### Embodiment 5

Reference is now made to FIG. 5, which schematically illustrates a head-mounted display apparatus in accordance with Embodiment 5 of the present invention. As illustrated, the head-mounted display apparatus includes:

a transmissive microdisplay 50, a visible light source 51, an illumination optics unit 52, an imaging optics unit 53 and an eye tracker module 54. The visible light source 51 is configured to illuminate a back of the microdisplay 50, such that light carrying an image is transmitted from a front of the microdisplay 50 along an optical axis 500. The illumination optics unit 52 is configured to receive and allow the image from the microdisplay 50 to pass through the illumination optics unit 52. The imaging optics unit 53 is configured to project the image from the microdisplay 50 into an eye of a user (as indicated by the arrowed solid lines in FIG. 5). The eye tracker module 54 includes an invisible light source and a sensor. The invisible light source is adapted to emanate an invisible light beam into the illumination optics unit 52 which then makes the invisible light beam travel along the optical axis 500. The imaging optics unit 53 is configured to receive and direct the invisible light beam into the eye of the user (as indicated by the arrowed dashed lines in FIG. 5). The sensor is configured to receive the invisible light beam reflected back from the eye of the user and to thereby capture an image of the eye. It is noted that the arrowed solid and dashed lines in FIG. 5 are intended merely to indicate directions of different light beams, and, in case of the directions being the same, the lines should coincide but are still presented in the figure as separate lines in order to show that they represent distinct light beams.

In this embodiment, the imaging optics unit 52 includes a first beam splitter 521 that is arranged with an angle of about 45 degrees relative to the optical axis 500. Additionally, the imaging optics unit 53 includes a second beam splitter 531 and an imaging lens 532, both arranged along the optical axis 500. The second beam splitter 531 has a first surface 531a for receiving and allowing both the image from the microdisplay 50 and the invisible light beam to pass therethrough. The imaging lens 532 is configured to reflect the image and the invisible light beam toward a second surface 531b of the second beam splitter 53. The second surface 531b is adapted to reflect the image and the invisible light beam into the eye of the user.

With similarity to the foregoing embodiments, the eye tracker module 54 further includes a processor for receiving the image of the eye from the sensor and for using an algorithm to calculate a position of the eye. The image received by the sensor is a real image for aiding the sensor to monitor the position of the eye. The monitoring of the position of the eye allows knowing a direction and angle of the eye staring at the image from the microdisplay, based on which a portion of the image at which the eye is staring can be determined. This enables the control of the displayed image and the tracking of an object. In addition, without affecting the user at all, the invisible light beam emanated from the invisible light source travels coaxially with the visible light along the optical axis 500 after it has passed through imaging optics unit 52, thereby resulting in an improvement in the accuracy of the object tracking. Further, the coaxial transmission of the beams establishes a known relationship between the sensor in the eye tracker module 53 and the microdisplay 50, thus making the eye tracker module 53 free of the need for calibration.

Furthermore, the transmissive microdisplay 50 is an LCoS display or a DLP display. The image from the microdisplay 50 is a virtual image. The invisible light source is an LED light source.

### Embodiment 6

With combined reference to FIGS. 5 and 6, this embodiment differs from Embodiment 5 in the structure of the imaging optics unit 53. In this embodiment, the imaging optics unit 53 includes a second beam splitter 531, an imaging lens 532 and a reflector 533. The second beam splitter 531 has a first surface 531a which allows the image from the microdisplay 50 to pass therethrough and reflects the invisible light beam toward the reflector 533. The first surface 531a is further configured to allow the invisible light beam reflected from the reflector 533 to pass therethrough into the eye of the user. The imaging lens 532 is configured to reflect the image that has passed through the first surface 531a toward the second surface 341b of the second beam splitter 531, which then reflects the image into the eye of the user, as shown in FIG. 6.

As can be understood from the foregoing description, the head-mounted display apparatuses constructed in accordance with the present invention is each provided with an eye tracker module including an invisible light source and a sensor. The invisible light source emanates an invisible light beam which is then received by an imaging optics unit and is directed thereby into an eye of the user. The sensor receives the invisible light beam reflected back from the eye of the user and thus captures an image of the eye, based of which a position of the eye is determinable by calculation. Monitoring the position of the eye allows obtaining a direction and an angle of the eye staring at an image. This makes it possible to control the displayed image and to track an object. In addition, the invisible light beam emanated from the invisible light source enters the illumination optics unit and thereby travels along an optical axis of the invisible light. This results in an improvement in the accuracy of the object tracking. Further, the invisible light beam does not have any impact on the user.

Whilst there have been described in the foregoing description preferred embodiments of the present invention, it is to be understood that the invention is not limited to these described embodiments. It is intended that all alterations and modifications made by those skilled in the art in light of what has been disclosed above fall within the scope of the appended claims.

What is claimed is:

1. A head-mounted display apparatus, comprising:
a reflective microdisplay;
a visible light source configured to illuminate the microdisplay;
an illumination optics unit configured to direct visible light emanated from the visible light source into the microdisplay, and allow light reflected from the microdisplay in the form of an image to pass therethrough and transmit along an optical axis;
an imaging optics unit configured to project the image from the microdisplay into an eye of a user; and
an eye tracker module, comprising:
an invisible light source configured to emanate an invisible light beam into the illumination optics unit, the illumination optics unit configured to reflect the invisible light beam along said optical axis, the imaging optics unit configured to receive and direct the invisible light beam into the eye of the user; and
a sensor configured to receive the invisible light beam reflected back from the eye of the user and to capture an image of the eye.

2. The head-mounted display apparatus according to claim 1, wherein the reflective microdisplay is a liquid crystal on silicon display or a digital light processing display.

3. The head-mounted display apparatus according to claim 1, wherein the image from the microdisplay projected into the eye of a user is a virtual image.

4. The head-mounted display apparatus according to claim 1, wherein the eye tracker module further comprises a processor for receiving the image of the eye from the sensor and for monitoring a position of the eye.

5. The head-mounted display apparatus according to claim 4, wherein the sensor provides a real image for monitoring the position of the eye.

6. The head-mounted display apparatus according to claim 4, wherein the processor calculates the position of the eye by using an algorithm.

7. The head-mounted display apparatus according to claim 1, wherein the imaging optics unit is disposed downstream to the illumination optics unit along said optical axis, the eye tracker module disposed on a first side of the illumination optics unit, and the visible light source disposed on a second side of the illumination optics unit opposite to the first side.

8. The head-mounted display apparatus according to claim 7, wherein the illumination optics unit comprises a first beam splitter arranged with an angle of about 45 degrees relative to said optical axis.

9. The head-mounted display apparatus according to claim 1, wherein the imaging optics unit comprises a second beam splitter and an imaging lens arranged along said optical axis, the second beam splitter having a first surface for receiving and allowing both the image from the microdisplay and the invisible light beam to pass therethrough, the imaging lens configured to reflect the image from the microdisplay and the invisible light beam toward a second surface of the second beam splitter, the second surface of the second beam splitter configured to reflect the image from the microdisplay and the invisible light beam into the eye of the user.

10. The head-mounted display apparatus according to claim 1, wherein the imaging optics unit comprises a second beam splitter and an imaging lens arranged along said optical axis and a reflector, the second beam splitter having a first surface that allows the image from the microdisplay to pass therethrough and reflects the invisible light beam toward the reflector, the first surface of the second beam splitter further configured to allow the invisible light beam reflected from the reflector to pass therethrough into the eye of the user, the imaging lens configured to reflect the image from the microdisplay toward a second surface of the second beam splitter, the second surface of the second beam splitter configured to reflect the image from the microdisplay into the eye of the user.

11. The head-mounted display apparatus according to claim 1, wherein the invisible light source is an infrared light-emitting diode light source.

12. A head-mounted display apparatus, comprising:
a reflective microdisplay;
a visible light source configured to illuminate the microdisplay;
a first illumination optics unit configured to direct visible light emanated from the visible light source into the microdisplay, and allow light reflected from the microdisplay in the form of an image to pass therethrough along an optical axis;
a second illumination optics unit disposed downstream to the first illumination optics unit along said optical axis and allowing the image from the microdisplay to pass therethrough;
an imaging optics unit configured to project the image from the microdisplay into an eye of a user; and
an eye tracker module, comprising:
an invisible light source configured to emanate an invisible light beam into the second illumination optics unit, the second illumination optics unit configured to reflect the invisible light beam along said optical axis, the imaging optics unit configured to receive and direct the invisible light beam into the eye of the user; and
a sensor configured to receive the invisible light beam reflected back from the eye of the user and to capture an image of the eye.

13. The head-mounted display apparatus according to claim 12, wherein the reflective microdisplay is a liquid crystal on silicon display or a digital light processing display.

14. The head-mounted display apparatus according to claim 12, wherein the image from the microdisplay projected into the eye of a user is a virtual image.

15. The head-mounted display apparatus according to claim 12, wherein the eye tracker module further comprises a processor for receiving the image of the eye from the sensor and for monitoring a position of the eye.

16. The head-mounted display apparatus according to claim 15, wherein the sensor provides a real image for monitoring the position of the eye.

17. The head-mounted display apparatus according to claim 15, wherein the processor calculates the position of the eye by using an algorithm.

18. The head-mounted display apparatus according to claim 12, wherein the first illumination optics unit, the second illumination optics unit and the imaging optics unit are successively arranged along said optical axis, the eye tracker module and the visible light source disposed on a same side of the second illumination optics unit and the first illumination optics unit, respectively.

19. The head-mounted display apparatus according to claim 18, wherein the first illumination optics unit comprises a first beam splitter arranged with an angle of about 45 degrees relative to said optical axis, the second illumination optics unit comprising a second beam splitter arranged with an angle of about 45 degrees relative to said optical axis, the first beam splitter and the second beam splitter being orthogonal to each other.

20. The head-mounted display apparatus according to claim 12, wherein the imaging optics unit comprises a third beam splitter and an imaging lens arranged along said optical axis, the third beam splitter having a first surface for receiving and allowing both the image from the microdisplay and the invisible light beam to pass therethrough, the imaging lens configured to reflect the image from the microdisplay and the invisible light beam toward a second surface of the third beam splitter, the second surface of the third beam splitter configured to reflect the image from the microdisplay and the invisible light beam into the eye of the user.

21. The head-mounted display apparatus according to claim 12, wherein the imaging optics unit comprises a third beam splitter and an imaging lens arranged along said optical axis and a reflector, the third beam splitter having a first surface that allows the image from the microdisplay to pass therethrough and reflects the invisible light beam toward the reflector, the first surface of the third beam splitter further configured to allow the invisible light beam reflected from the reflector to pass therethrough into the eye of the user, the imaging lens configured to reflect the image from the microdisplay toward a second surface of the third beam splitter, the second surface of the third beam splitter configured to reflect the image from the microdisplay into the eye of the user.

22. The head-mounted display apparatus according to claim 12, wherein the invisible light source is an infrared light-emitting diode light source.

23. A head-mounted display apparatus, comprising:
a transmissive microdisplay;
a visible light source configured to illuminate a back of the microdisplay, such that light in the form of an image is transmitted from a front of the microdisplay along an optical axis;
an illumination optics unit configured to receive and allow the image from the microdisplay to pass therethrough;
an imaging optics unit configured to project the image from the microdisplay into an eye of a user; and
an eye tracker module, comprising:
an invisible light source configured to emanate an invisible light beam into the illumination optics unit, the illumination optics unit configured to reflect the invisible light beam along said optical axis, the imaging optics unit configured to receive and direct the invisible light beam into the eye of the user; and
a sensor configured to receive the invisible light beam reflected back from the eye of the user and to capture an image of the eye.

24. The head-mounted display apparatus according to claim 23, wherein the illumination optics unit comprises a first beam splitter arranged with an angle of about 45 degrees relative to said optical axis.

25. The head-mounted display apparatus according to claim 23, wherein the imaging optics unit comprises a second beam splitter and an imaging lens arranged along said optical axis, the second beam splitter having a first surface for receiving and allowing both the image from the microdisplay and the invisible light beam to pass therethrough, the imaging lens configured to reflect the image from the microdisplay and the invisible light beam toward a second surface of the second beam splitter, the second surface of the second beam splitter configured to reflect the image from the microdisplay and the invisible light beam into the eye of the user.

26. The head-mounted display apparatus according to claim 23, wherein the imaging optics unit comprises a second beam splitter and an imaging lens arranged along said optical axis and a reflector, the second beam splitter having a first surface that allows the image from the microdisplay to pass therethrough and reflects the invisible light beam toward the reflector, the first surface of the second beam splitter further configured to allow the invisible light beam reflected from the reflector to pass therethrough into the eye of the user, the imaging lens configured to reflect the image from the microdisplay toward a second surface of the second beam splitter, the second surface of the second beam splitter configured to reflect the image from the microdisplay into the eye of the user.
